(19) United States
(12) Patent Application Publication
(10) Pub. No.: US 2017/0180357 A1
(43) Pub. Date: Jun. 22, 2017

(54) ACCESS POINT SELECTION AND AUTHENTICATION FOR IOT DEVICE

(71) Applicants: Chittabrata GHOSH, Fremont, CA (US); Jeonghun PARK, Austin, TX (US); Thomas J. KENNEY, Portland, OR (US)

(72) Inventors: Chittabrata GHOSH, Fremont, CA (US); Jeonghun PARK, Austin, TX (US); Thomas J. KENNEY, Portland, OR (US)

(21) Appl. No.: 14/979,214

(22) Filed: Dec. 22, 2015

(51) Int. Cl. H04L 29/06; H04W 84/12

(52) U.S. Cl. CPC H04L 63/0853; H04W 84/12; H04L 63/10

(57) ABSTRACT

The present disclosure is directed to access point selection and authentication for an Internet of Things (IoT) device in a wireless local area network. A device encodes a device class identifier in a request frame, the device class identifier to identify a device class type of a device. The device transmits the request frame from the device to an access point and decodes a support code encoded in the response frame received at the device from the access point in response to the device class identifier. The device determines that the access point is capable of associating with the device based at least in part on the response frame.

### TECHNICAL FIELD

Embodiments of the present disclosure generally relate to connectivity within the Internet of Things (IoT) and, more particularly, to access point selection and authentication for an IoT device.

### BACKGROUND

The Internet of Things (IoT) is a network of physical devices or objects embedded with electronics, software, sensors, and network connectivity, which enables these devices or objects to collect and exchange data. The IoT network allows IoT devices or objects to be sensed and controlled remotely across existing network infrastructure, creating opportunities for more direct integration between the physical world and computer-based systems, and resulting in improved efficiency, accuracy, and economic benefit. Each IoT device or object is uniquely identifiable through an embedded computing system.

IoT devices or objects may include a variety of devices having a variety of different form factors. IoT devices or objects may include wearable technology worn by consumers. Wearable technology often tracks information related to a consumer's health or fitness. Most wearable technology is worn on a consumer's wrist, e.g., smart watches or bracelets, but an increasing number may be coupled to the body, e.g., worn around a finger, hung around the neck, or sewn or clipped into various garments worn by consumers. Wearable technology is becoming widespread as the IoT expands its reach.

IoT devices or objects may access an existing global network infrastructure by selecting and associating with an Access Point (AP). Some APs may not support certain IoT devices. This may be the case with IoT devices that transmit low power signals to conserve or constrain power usage due to the difficulty involved in recharging or replacing batteries in many IoT devices. A need remains, therefore, for improved systems and methods that allow IoT devices to select and authenticate to APs while conserving or constraining power usage.

### BRIEF DRAWINGS DESCRIPTION

The present disclosure describes various embodiments that may be understood and fully appreciated in conjunction with the following drawings:

FIG. 1A illustrates an exemplary wireless connectivity procedure for a wireless local area network (WLAN), in accordance with some embodiments.

FIG. 1B illustrates an exemplary request frame, in accordance with some embodiments.

FIG. 1C illustrates an exemplary response frame, in accordance with some embodiments.

FIG. 1D illustrates an exemplary advertisement protocol element, in accordance with some embodiments.

FIG. 2 illustrates an exemplary method for an IoT device to select an AP, in accordance with some embodiments.

FIG. 3 illustrates an exemplary method for an AP to authenticate an IoT device, in accordance with some embodiments.

FIG. 4 illustrates an exemplary system, according to some embodiments.

### DETAILED DESCRIPTION

The present disclosure describes embodiments with reference to the drawing figures listed above. Persons of ordinary skill in the art will appreciate that the description and figures illustrate rather than limit the disclosure and that, in general, the figures are not drawn to scale for clarity of presentation. Such skilled persons will also realize that many more embodiments are possible by applying the inventive principles contained herein and that such embodiments fall within the scope of the disclosure that is not to be limited except by the claims.

In the following detailed description, reference is made to the accompanying drawings that form a part hereof, wherein like numerals designate like parts throughout, and in which are shown by way of illustration embodiments where the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrases “A or B” and “A and/or B” mean (A), (B), (A) or (B), or (A and B). For the purposes of the present disclosure, the phrases “A, B, or C” and “A, B, and/or C” mean (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The present disclosure may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other.

Embodiments of the present disclosure include a system and method to select and authenticate an access point for an IoT device.

In an embodiment, a device may include memory circuitry to store instructions and processing circuitry to execute the instructions stored in the memory circuitry to encode a device class identifier in a request frame, the device class identifier to identify a device class type of a device; transmit the request frame from the device to an access point; decode a support code encoded in the response frame received at the device from the access point in response to the device class identifier; and determine that the access point is capable of associating with the device based at least in part on the response frame.

In an embodiment, a device may include memory circuitry to store instructions and processing circuitry to execute the instructions stored in the memory circuitry to decode a device class identifier from a request frame received at an access point from a device, the device class identifier to identify a type of the device; encode a support code in a response frame based at least in part on the device class identifier decoded from the request frame; and transmit the response frame from the access point to the device.

Other embodiments may be described and/or claimed.

The Institute of Electrical and Electronics Engineers (IEEE) has developed an 802.11 standard for wireless local area networks. The IEEE 802.11 standard specifies an over-the-air interface between a device or station and an access point (AP) or between two wireless devices. The IEEE 802.11 standard provides a method for supplying different levels of access to different wireless devices in a wireless local area network (WLAN). Each wireless device and AP in a WLAN keeps an authentication state and an association state with each other wireless device and AP that it contacts. The IEEE 802.11 standard and the many associated amendments and standards are well known to a person of ordinary skill in the art.

In an embodiment, the IEEE 802.11 standard may describe a wireless scanning, authenticating, and associating procedure for a wireless local area network (WLAN). A WLAN may include one or more devices and one or more access points (APs). The one or more devices may gain access to a wired network by connecting to an AP consistent with the 802.11 standard.

A device may associate with an AP using a three step process defined in the 802.11 standard that includes scanning, authenticating, and associating. During scanning, the device may transmit a probe request to discover any AP within a predetermined proximity. The probe request may advertise data rates and other communication capabilities of the device. The device may transmit the probe request in any known manner, e.g., simulcast, multicast, and the like.

In response to receiving the probe request, the AP may transmit a probe response once AP determines communication compatibility with the device by e.g., identifying a common supported data rate. The probe response may include an identification of a network, supported data rates, encryption types, and other communication capabilities as is well known to a person of ordinary skill in the art. The device may determine compatible APs from the received probe response.

During authenticating, the device may transmit an authentication request to AP. The authentication request may include a predetermined authentication request sequence, e.g., 0x0001. The AP, in turn, may respond to the device by transmitting an authentication response after receiving the authentication request. The authentication response may include a predetermined authentication response sequence, e.g., 0x0002. If the AP receives a frame other than the authentication frame from the device, it may respond with a deauthentication frame to place the device into an unauthenticated unassociated state. The device may be authenticated to more than a single AP but the device may only be associated with a single AP.

During associating, the device may transmit an association request to the AP in response to which, the AP may transmit an association response to the device. The association request may identify an encryption type and other communication capabilities. If the AP receives a frame from the device that is authenticated but not yet associated, it may respond with a disassociation frame to place the device in an authenticated but unassociated state. The AP may associate with the device in response to determining that the encryption or other communication capabilities in the association request match the capabilities of the AP. The association response may include association identification for the device granting access to an associated wired network.

In an embodiment in which the device may be an IoT device, the AP may not support the device particularly if the device transmits low power signals due to constraints on power usage common to IoT devices. The device may expend power during the scanning, authenticating, and associating without the certainty that such power consumption may result in a successful association with the AP.

A table 200 tabulates a sum of power or energy usage associated with scanning, authenticating, and associating as described above for a WLAN having the following exemplary characteristics:

TABLE 200

| Reference Rate | 6 | Mbps |
|---|---|---|
| Reference Power | Transmit 280 mA | |
| | Receive 100 mA | |
| | Listen 50 mA | |
| Ack Frame Size | 14 | bytes |
| SIFS | 16 | μs |
| AIFS | 34 | μs |
| Backoff Interval | 175.5 | μs |
| Volts | 1.1 | V |

It is not uncommon for a total power consumption to reach in excess of 300 μJ, which may be undesirably large for certain devices, e.g., IoT devices, especially when considering that such power consumption does not guarantee that the AP successfully wirelessly associates with the device after scanning, authenticating, and associating. Put differently, the AP may determine that the device may not be compatible or otherwise capable of establishing a wireless communication channel but not before both the AP and the device have consumed undesirably large amounts of power, e.g., over 300 μJ, through scanning, associating, and authenticating under the 802.11 standard.

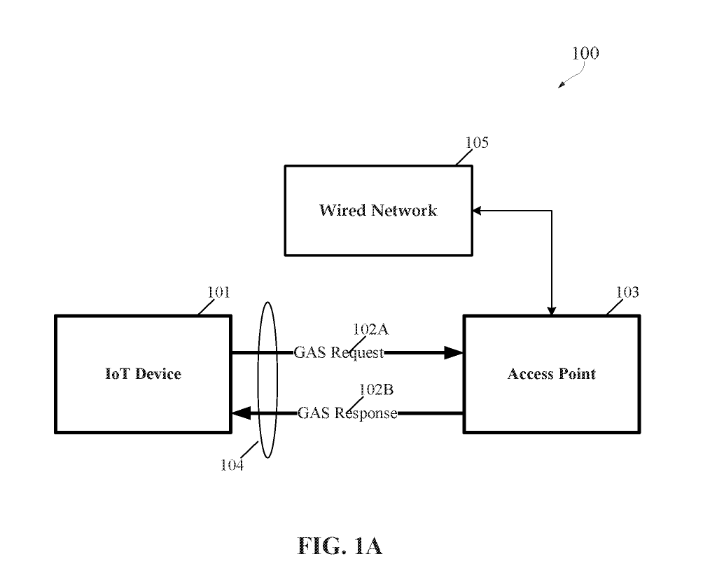

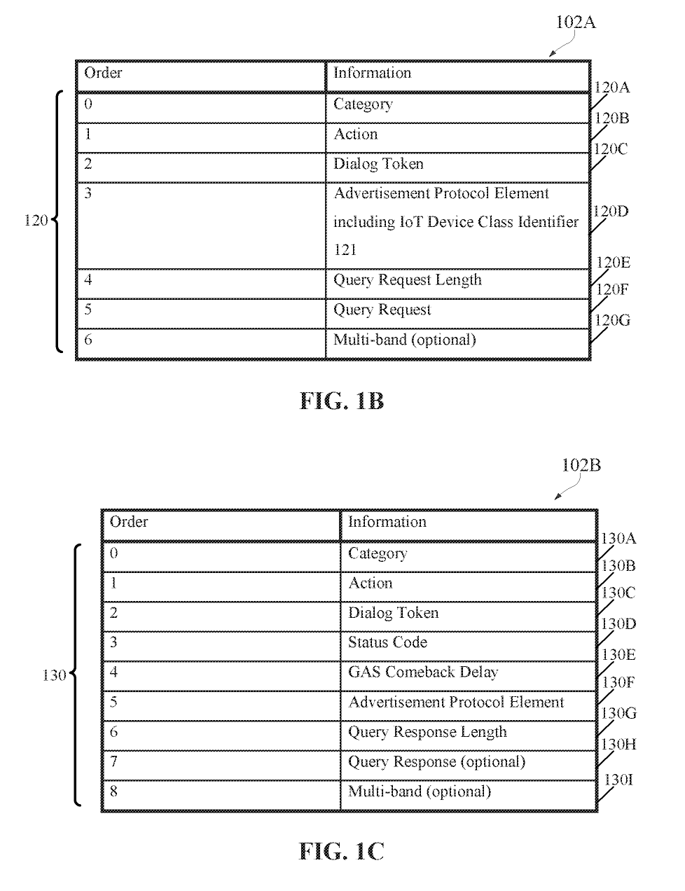

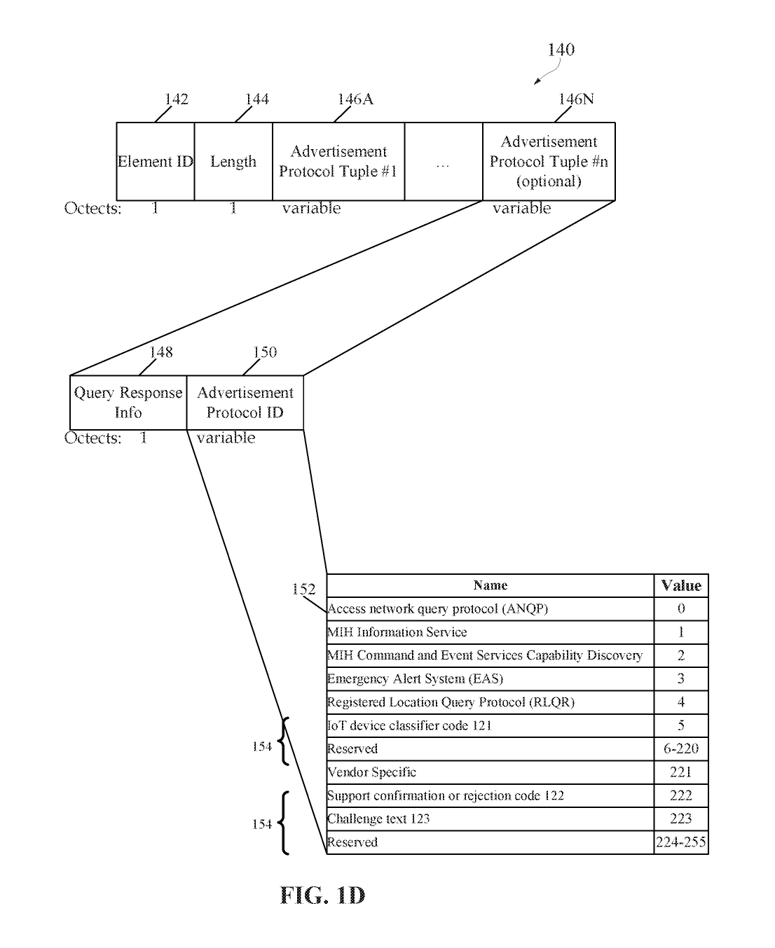

FIG. 1A illustrates an exemplary wireless connectivity procedure for a wireless local area network (WLAN) 100, in accordance with some embodiments. Referring to FIG. 1A, WLAN 100 may include an IoT device 101 and an access point (AP) 103.

A person of ordinary skill in the art should recognize that WLAN 100 is shown as including a single IoT device 101 and a single AP 103 for simplicity only. WLAN 100 may include a plurality of IoT devices 101 and a plurality of APs 103 as well as a plurality of other devices capable of wireless communication. Also, a plurality of IoT devices 101 may gain access to a wired network 305 by connecting to AP 103.

IoT device 101 may be any electronic device capable of creating, receiving, or transmitting information over a wireless communications channel 104, e.g., user equipment, a computer, a personal computer (PC), a desktop computer, a laptop computer, a notebook computer, a netbook computer, a tablet computer, an ultrabook computer, a smart phone, embedded electronics, smart phones, biometric devices, heart monitoring implants, transponders on farm animals, electric clams in coastal waters, thermostats, home and kitchen appliances, sensors of any kind and size for any application, wearable computing devices, gaming consoles, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of IoT device 101 described herein, may be included or omitted in various embodiments of IoT device 101, as suitably desired. In some embodiments, IoT device 101 may be configured to be compatible with protocols and frequencies associated with the IEEE 802.11 family of standards for WLANs and/or for wireless docking, although the examples are not limited in this respect. A person of ordinary skill in the art should recognize that IoT devices 101 vary in type, size, and application.

IoT device 101 may include wearable devices worn by consumers that include sensors and other devices. Wearable technology often tracks information related to a consumer's health or fitness. Most wearable technology is worn on a consumer's wrist, e.g., smart watches or bracelets, but an increasing number may be coupled to the body, e.g., worn around a finger, hung around the neck, or sewn or clipped into various garments worn by consumers. In some embodiments, IoT device 101 may include sensors of any type known to a person of ordinary skill in the art with and without having other computing capabilities.

IoT device 101 may include an adapter, card, or other embedded device to provide wireless connectivity with, e.g., AP 103. IoT device 101 may have wireless communication capabilities in accordance with, in excess of, in addition to, or in difference to those capabilities described under the 802.11 family of standards. IoT device 101 may also be suitable to transmit and/or receive communications in accordance with other techniques.

IoT device 101 may be uniquely identifiable through an embedded computing system or otherwise and may be able to interoperate within an existing and well-known global network infrastructure, e.g., wired network 105. In some embodiments, AP 103 may give IoT device 101 access to a global network, e.g., the Internet, through wired network 105 or otherwise.

IoT device 101 may include logic and/or features (e.g., chipsets, processor circuits, memory, protocol stacks, and the like) to operate according to the 802.11 family of standards to transmit or receive communication signals via wireless communication channel 104. The components and features of IoT device 101 may be implemented using any combination of discrete circuitry, application specific integrated circuits (ASICs), logic gates and/or single chip architectures. Further, the features of IoT device 101 may be implemented using microcontrollers, programmable logic arrays and/or microprocessors or any combination of the foregoing where suitably appropriate. It is noted that hardware, firmware, and/or software elements may be collectively or individually referred to herein as “logic” or “circuit.”

AP 103 may be any electronic device that allows a wireless device, e.g., IoT device 101, to connect to a wired network 105 using a wireless communications channel 304. AP 103 may be, e.g., a wireless router either standing alone or combined with converged devices that include the AP 103, router, switch, modem, or the like. AP 103 may function as a bridge between IoT device 101 and wired network 105 for network access. AP 103 may include an adapter, card, or other embedded device to provide wireless connectivity with, e.g., IoT device 101. AP 103 may have wireless communication capabilities in accordance with, in excess of, in addition to, or in difference to those capabilities described under the 802.11 family of standards. AP 103 may also be suitable to transmit and/or receive communications in accordance with other techniques.

AP 103 may communicate with a plurality of IoT devices 101 within a predetermined geographical radius, e.g., 100 meters, although the range of communication can vary significantly depending on indoor or outdoor placing, height above ground, nearby obstructions, other electronic devices that might actively interfere with the signal by broadcasting on the same frequency, type of antenna, current weather, operating radio frequency, and the power of output devices. AP 103 may encrypt or otherwise secure communications over channel 104 with IoT device 101 as is well known to a person of ordinary skill in the art. AP 103 may include logic and/or features to uniquely identify it to other devices coupled to WLAN 100 including IoT device 101. Likewise, IoT device 101 may include logic and/or features to uniquely identify it to other devices coupled to WLAN 100 including AP 103.

In some embodiments, IoT device 101 and AP 103 may be arranged to operate and may each include logic and/or features (e.g., chipsets, processor circuits, memory, protocol stacks, and the like) according to one or more wireless network technologies including those associated with the IEEE 802.11 family of standards.

In some embodiments, IoT device 101 may establish communication channel 104 prior to or without full authentication and association. To do so, IoT device 101 may transmit a request frame 102A to AP 103 that advertises the IoT device 101 to AP 103. In response, AP 103 may transmit a response frame 102B. Request frame 102A or response frame 102B may be a formatted unit of digital data that includes a header followed by a packet. Request frame 102A or response frame 102B may include frame synchronization elements consisting of a sequence of bits or symbols that indicate to AP 103 or IoT device 101, respectively, the beginning and end of the payload data within a stream of symbols or bits it receives. If AP 103 receives request frame 102A in the middle of transmission, AP 103 may ignore the data until AP 103 detects a new frame synchronization sequence. Likewise, if IoT device 101 receives response frame 102B in the middle of transmission, IoT device 101 may ignore the data until IoT device 101 detects a new frame synchronization sequence. Request frame 102A or response frame 102B may be a data frame in a data link layer (layer 2) of the Open Systems Interconnection (OSI) model that governs data transfers between adjacent network entities. In some embodiments, request frame 102A may be a modified Generic Advertisement Service (GAS) request frame under the 802.11 standard as is detailed below. Likewise, response frame 102B may be a modified GAS response frame under the 802.11 standard as is detailed below.

FIG. 1B illustrates an exemplary request frame 102A, in accordance with some embodiments. Referring to FIG. 1B, request frame 102A may include fields or orders 120. Field 120A may be a category field, field 120B may be an action field, field 120C may be a dialog token, field 120D may be an advertisement protocol element, field 120E may be a query request length, field 120F may be the query request, and field 120G may be an optional multi-band. In some embodiments, request frame fields 120A-G may largely correspond to orders 0-6, respectively, in GAS initial request frame as defined by the 802.11 family of standards with the exception of IoT class identifier 121 encoded therein. In some embodiments, IoT device 101 may encode dialog token in field 120C of request frame 102A to identify the device that has requested communication with AP 103. IoT device 101 may encode an IoT device class identifier 121 with the advertisement protocol element in field 120D. IoT device class identifier 121 may identify IoT device 101 to AP 103 as an IoT type of device having predetermined transmission characteristics.

FIG. 1C illustrates an exemplary response frame 102B, in accordance with some embodiments. Referring to FIG. 1C, response frame 102B may include fields or orders 130. Field 130A may be a category field, field 130B may be an action field, field 130C may be a dialog token, field 130D may be a status code, field 130E may be a GAS comeback delay, field 130F may be an advertisement protocol element, field 130G may be a query response length, field 130H may be an optional query response, and field 130I may be an optional multi-band. In some embodiments, response frame fields 130A-I may largely correspond to orders 0-8, respectively, in a GAS initial response frame as defined by the 802.11 family of standards.

FIG. 1D illustrates an exemplary advertisement protocol element 140, in accordance with some embodiments. Referring to FIG. 1D, advertisement protocol element 140 may contain information that identifies a particular advertisement protocol and its delivery method. Advertisement protocol element 140 may be included in request frame 102A or response frame 102B and may include an element identification field 142, a length field 144, and a plurality of advertisement protocol element tuplets 146A-N. Element identification field 142 and length field 144 may be octets while advertisement protocol tuplets 146A-N may vary in size. Element identification field 142 may identify the type of element as an advertisement protocol information element. Length field 144 may indicate a length of the of the information element.

Advertisement protocol element 140 may include a plurality of advertisement protocol tuplets 146A-N, each of which may include a query response information field 148 and an advertisement protocol identification field 150. Query response information field 148 may indicate a maximum number of octets IoT device 101 may transmit in advertisement protocol element 140. Advertisement protocol identification field 150 may identify a type of advertisement protocol supported by IoT device 101. For example, if field 152 equals zero, IoT device 101 supports Access Network Query Protocol (ANQP).

IoT device 101 may encode an IoT device class identifier 121 in an advertisement protocol element 110 included in request frame 102A. In some embodiments, IoT device 101 may encode IoT device class identifier 121 in any of reserved value fields 354. In FIG. 1D, IoT device class identifier 121 is shown encoded into reserved value field 5 of advertisement protocol element 140 included in request frame 102A.

AP 103 may encode a support confirmation or rejection code 122 in an advertisement protocol element 140 included in response frame 102B. In some embodiments, AP 103 may encode support confirmation or rejection code 122 in any of reserved fields 154. In FIG. 1D, support confirmation or rejection code 122 is shown encoded into reserved value field 222 of advertisement protocol element 140 included in response frame 102B.

AP 103 may generate challenge text 123 in response to receiving request frame 102A. More particularly, AP 103 may generate challenge text 123 after determining that AP 103 may support IoT device 101 by decoding IoT device class identifier 121 encoded by IoT device 101 in request frame 102A. That is, AP 103 may decode IoT device class identifier 121 encoded in response frame 102A and, based on IoT device class identifier 121, determine that AP 103 may support IoT device 101. AP 103 may then generate challenge text 123 based on dialog token encoded by IoT device 101 in request frame 102A. AP 103 may encode challenge text 123 in an advertisement protocol element 140 included in response frame 102B. In some embodiments, AP 103 may encode challenge text 123 in any of reserved value fields 154 of advertisement protocol element of response frame 102B. In FIG. 1D, challenge text 123 is shown encoded into reserved value field 223 of advertisement protocol element 140 included in response frame 102B.

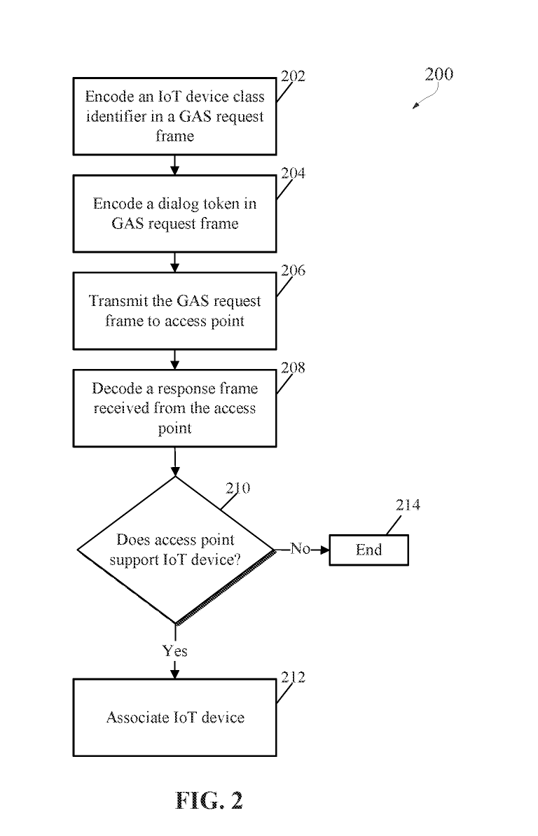

FIG. 2 illustrates an exemplary method 200 for an IoT device to select an AP, in accordance with some embodiments. Referring to FIGS. 1A-D and 2, at step 202, IoT device 101 may encode an IoT device class identifier 121 in an advertisement protocol element included in request frame 102A. IoT device class identifier 121 may identify IoT device 101 to AP 103 as a particular type of device, e.g., an IoT device, having particular predetermined operating and transmission characteristics, e.g., low power signal transmission. In some embodiments, IoT device 101 may encode IoT device class identifier 121 in any of reserved fields 154 (values 5-220) of GAS initial request frame 102A. For example, if IoT device 101 sets value 5 of reserved field 154 to 1 in request frame 102A, IoT device 101 may be identified to AP 103 as an IoT type of device when AP 103 decodes request frame 102A. In some embodiments, IoT device 101 may encode IoT device class identifier 121 in a GAS initial request frame 102A, e.g., in any of reserved fields 154.

At 204, IoT device 101 may encode a dialog token 120C in request frame 102A to identify IoT device 101 as the device having transmitted the request frame 102A to AP 103. Dialog tokens encoded in fields 120C and 130C are used to match requests to responses as is well known to a person of ordinary skill in the art. At 206, IoT device 206 may wirelessly transmit request frame 102A to AP 103 by any method known to a person of ordinary skill in the art. At 208, IoT device 101 may decode a response frame 102B received from AP 103 to determine, at 210, whether AP 103 supports IoT device 101 based on decoding response frame 102B. In some embodiments, IoT device 101 may decode support confirmation code 122 encoded by AP 103 in any of reserved fields 154 of advertisement protocol element included in response frame 102B. At 412, if AP 103 supports IoT device 101 as confirmed by support confirmation code 122, IoT device 101 proceeds to associate with AP 103 using, e.g., associating and authenticating under the IEEE 802.11 standard. If AP 103 does not support IoT device 101, at 214, IoT device 101 does not attempt to authenticate or associate any further with AP 103 to thereby conserve or constrain power usage.

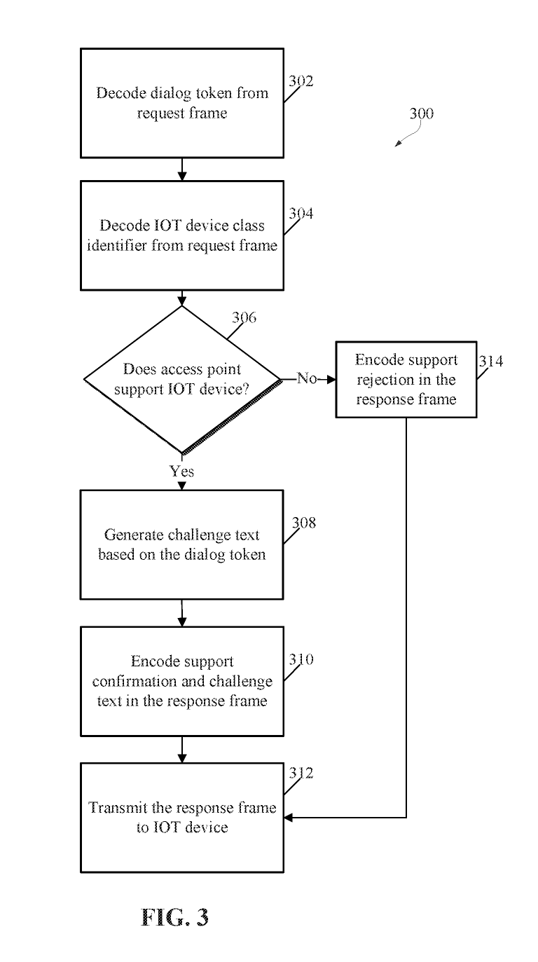

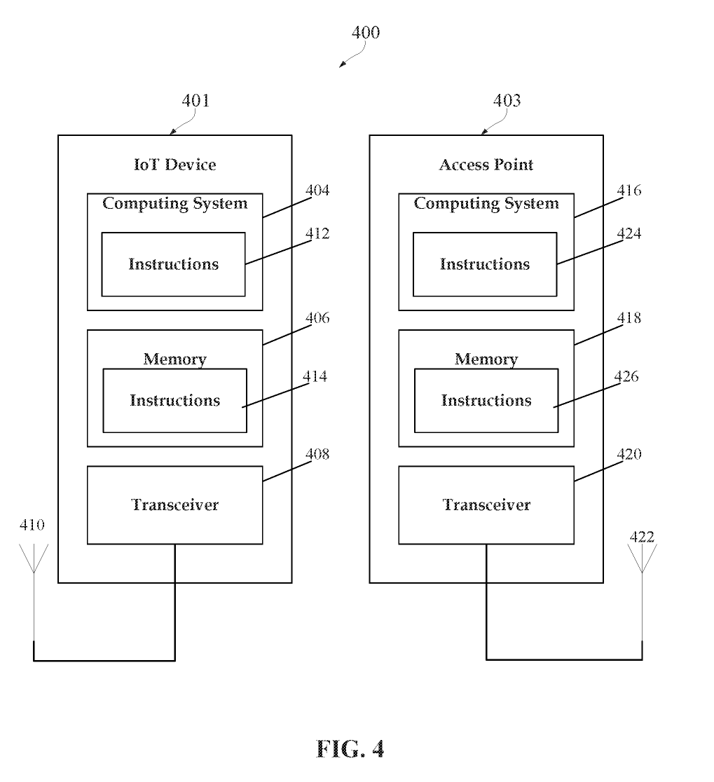

FIG. 3 illustrates an exemplary method 300 for AP 103 to authenticate IoT device 101, in accordance with some embodiments. At 302, AP 103 may decode dialog token 120C encoded by device 101 in request frame 102A. At 304, AP 103 may decode IoT device class identifier 121 encoded by device 101 in advertisement protocol element 140 in request frame 102A. At 306, AP 103 may determine whether it supports IoT device 101 based at least in part on IoT device class identifier 121. If AP 103 supports IoT device 101, at 308, AP 103 may generate challenge text 123 based on dialog token encoded in field 120C of advertisement protocol element 140 included in request frame 102A. At 310, AP 103 may encode support confirmation code 122 and challenge text 123 in response frame 102B. In some embodiments, AP 103 may encode support confirmation code 122 and challenge text 123 in advertisement protocol element of a GAS response frame 102B. If, on the other hand, AP 103 determines that it does not support IoT device 101 at 306 based on IoT device class identifier 121, at 314, AP 103 may encode support rejection code 122 in response frame 120B. At 3512, AP 103 may transmit response frame 102B to IoT device 101.

FIG. 4 illustrates an exemplary system 400, according to some embodiments. Referring to FIG. 4, system 400 may include an IoT device 401 and an AP 403, which may be an access point or any other entity (including a station under the 802.11 family of standards) that can provide network access/coverage for IoT device 601.

IoT device 401 may include computing system 404, memory 406, transceiver 408 (including at least one antenna 410), instructions 412 and 414, and possibly other components and sensors of any type known to a person of ordinary skill in the art (not shown). AP 403 may include computing system 416, memory 418, transceiver 420 (including at least one antenna 422), instructions 424 and 426, and possibly other components (not shown). While similar from a block diagram standpoint, it will be apparent to those of skill in the art that the configuration and details of the operation of IoT device 401 and AP 403 may be similar, or substantially different, depending on the exact device, role, and application. In some embodiments, IoT device 401 may include sensors of any kind with or without computing capabilities.

Computing system 404 and computing system 416 each may comprise one or more central processing units (CPUs), graphics processing units (GPUs), accelerated processing units (APUs), or various combinations thereof. Computing system 404 may provide processing and control functionalities for IoT device 401 and computing system 416 may provide processing and control functionalities for AP 403. Computing system 404 and computing system 416 may each include sensors and other logic and features consistent with their role and application.

Memory 406 and memory 418 each may comprise one or more transient and/or static memory units configured to store instructions, e.g., instructions 412 or 424, and data for IoT device 401 and AP 403, respectively. Transceiver 408 and transceiver 420 each may comprise one or more transceivers including, for an appropriate station or responder, a multiple-input and multiple-output (MIMO) antenna to support MIMO communications. Transceiver 408 receives signals from and transmits signals to AP 403 (and perhaps other entities as well). Likewise, transceiver 420 receives signals from and transmits signals back to IoT device 401 (and perhaps other entities as well).

Instructions 412 and 414 may comprise one or more sets of instructions or software that, when executed on a device (or machine), cause such device (or machine) to perform any of the methodologies discussed herein. Instructions 412 and 414 (also referred to as computer- or machine-executable instructions) may reside, completely or at least partially, within computing system 404 and/or the memory 406 during execution thereof by IoT device 401. While instructions 412 and 414 are illustrated as separate, they can be part of the same whole. Computing system 404 and memory 406 also may comprise machine-readable media.

Instructions 424 and 426 may comprise one or more sets of instructions or software that, when executed on a device (or machine), cause such device (or machine) to perform any of the methodologies discussed herein. Instructions 424 and 426 (also referred to as computer- or machine-executable instructions) may reside, completely or at least partially, within computing system 416 and/or the memory 418 during execution thereof by AP 403. While instructions 424 and 426 are illustrated as separate, they can be part of the same whole. Computing system 416 and memory 418 also may comprise machine-readable media.

In FIG. 4, processing and control functionalities are illustrated as being provided by computing systems 404 and 416 along with associated instructions 412, 414, 424, and 426. However, these are only examples of processing circuitry that comprise programmable logic or circuitry (e.g., as encompassed within a general-purpose processor or other programmable processor) that is temporarily configured by software or firmware to perform certain operations. In various embodiments, processing circuitry may comprise dedicated circuitry or logic that is permanently configured (e.g., within a special-purpose processor, application specific integrated circuit (ASIC), or array) to perform certain operations. A person of ordinary skill in the art will appreciate that a decision to implement a processing circuitry mechanically, in dedicated and permanently configured circuitry, or in temporarily configured circuitry (e.g., configured by software) may be driven by, for example, cost, time, energy-usage, package size, or other considerations.

Accordingly, the term “processing circuitry” should be understood to encompass a tangible entity, be that an entity that is physically constructed, permanently configured (e.g., hardwired), or temporarily configured (e.g., programmed) to operate in a certain manner or to perform certain operations described herein.

The present disclosure includes an abstract that complies with 37 C.F.R. §1.72(b) to allow the reader to ascertain the nature and gist of the technical disclosure. The abstract, however, should not limit or interpret the scope or meaning of the claims. The following claims are hereby incorporated into the detailed description, with each claim standing on its own as a separate embodiment.

The terms “computer readable medium,” “machine-readable medium,” and the like should be taken to include a single medium or multiple media (e.g., a centralized or distributed database, and/or associated caches and servers) that store the one or more sets of instructions. The terms shall also be taken to include any medium that is capable of storing, encoding or carrying a set of instructions for execution by the machine and that cause the machine to perform any one or more of the methodologies of the present disclosure. The terms “computer readable medium” and “machine-readable medium” shall accordingly be taken to include “computer storage medium,” “machine storage medium,” and the like (e.g., tangible sources including, solid-state memories, optical and magnetic media, or other tangible devices and carriers but excluding signals per se, carrier waves and other intangible sources) as well as “computer communication medium,” “machine communication medium” and the like (intangible sources including, signals per se, carrier wave signals and the like).

### Examples

The present disclosure describes various example embodiments including, but are not limited to:

Example 1 may be a device comprising memory circuitry to store instructions and processing circuitry to execute the instructions stored in the memory circuitry to: encode a device class identifier in a request frame, the device class identifier to identify a device class type of a device; transmit the request frame from the device to an access point; decode a support code encoded in a response frame received at the device from the access point in response to the device class identifier; and determine that the device is capable of authenticating and associating with the access point based at least in part on the response frame.

Example 2 may be example 1, wherein the processing circuitry is to further execute the instructions stored in the memory device to encode the device class identifier in a generic advertisement service (GAS) request frame.

Example 3 may be example 2, wherein the processing circuitry is to further execute the instructions stored in the memory device to encode the device class identifier in an advertisement protocol element of the GAS request frame.

Example 4 may be example 1, wherein the processing circuitry is to further execute the instructions stored in the memory device to encode the device class identifier in a reserved value of the advertisement protocol element of the GAS request frame.

Example 5 may be any of examples 1 to 5, wherein the processing circuitry is to further execute the instructions stored in the memory device to advertise the device to the access point using the request frame.

Example 6 may be any of examples 1 to 5, wherein the processing circuitry is to further execute the instructions stored in the memory device to wirelessly transmit the request frame from the device to the access point.

Example 7 may be any of examples 1 to 6, wherein the processing circuitry is to further execute the instructions stored in the memory device to encode a dialog token in the request frame.

Example 8 may be example 1, wherein the processing circuitry is to further execute the instructions stored in the memory device to decode a challenge text encoded in the response frame based at least in part on the dialog token.

Example 9 may be any examples 1 to 8, wherein the processing circuitry is to further execute the instructions stored in the memory device to decode the support code encoded in an advertisement protocol element of a generic advertisement service (GAS) response frame.

Example 10 may be example 1, wherein the processing circuitry is to further execute the instructions stored in the memory device to decode the support code encoded in a reserved value of the advertisement protocol element of the GAS response frame.

Example 11 may be one or more computer-readable media comprising instructions stored thereon that, when executed by one or more processors, cause the one or more processors to encode a device class identifier in a request frame, the device class identifier to identify a device class type of the device; transmit the request frame from the device to an access point; decode a support code encoded in a response frame received at the device from the access point in response to the request frame, the support code to indicate whether the access point is capable of associating with the device; and associate the device with the access point in response to the support code.

Example 12 may be example 11, wherein the instructions, when executed by the one or more processors, cause the one or more processors further to encode the device class identifier in a generic advertisement service (GAS) request frame using the device.

Example 13 may be example 12, wherein the instructions, when executed by the one or more processors, cause the one or more processors further to encode the device class identifier in an advertisement protocol element of the GAS request frame.

Example 14 may be any of examples 11 to 13, wherein the instructions, when executed by the one or more processors, cause the one or more processors further to encode the device class identifier in a reserved value of the advertisement protocol element of the GAS request frame.

Example 15 may be any of examples 11 to 14, wherein the instructions, when executed by the one or more processors, cause the one or more processors further to advertise the device to the access point using the request frame.

Example 16 may be any of examples 11 to 15, wherein the instructions, when executed by the one or more processors, cause the one or more processors further to wirelessly transmit the request frame from the device to the access point.

Example 17 may be any examples 11 to 16, wherein the instructions, when executed by the one or more processors, cause the one or more processors further to encode a dialog token in the request frame.

Example 18 may be any of examples 11 to 17, wherein the instructions, when executed by the one or more processors, cause the one or more processors further to decode a challenge text encoded in the response frame based at least in part on the dialog token.

Example 19 may be any of examples 11 to 18, wherein the instructions, when executed by the one or more processors, cause the one or more processors further to decode the support code encoded in an advertisement protocol element of a generic advertisement service (GAS) response frame.

Example 20 may be example 11, wherein the instructions, when executed by the one or more processors, cause the one or more processors further to decode the support code encoded in a reserved value of the advertisement protocol element of the GAS response frame.

Example 21 may be an apparatus comprising means for encoding a device class identifier in a request frame, the device class identifier to identify a device class type of a device; means for transmitting the request frame from the device to an access point; means for decoding a support code encoded in a response frame received at the device from the access point in response to the request frame; and means for determining that the access point is capable of associating with the device based at least in part on the support code.

Example 22 may be example 21, further comprising means for encoding the device class identifier in a generic advertisement service (GAS) request frame using the device.

Example 23 may be example 22, further comprising means for encoding the device class identifier in an advertisement protocol element of the GAS request frame.

Example 24 may be example 23, further comprising means for encoding the device class identifier in a reserved value of the advertisement protocol element of the GAS request frame.

Example 25 may be any of examples 21 to 25, further comprising means for advertising the device to the access point using the request frame.

Example 26 may be example 21, further comprising means for wirelessly transmitting the request frame from the device to the access point.

Example 27 may be any of examples 25 to 26, further comprising means for encoding a dialog token in the request frame.

Example 28 may be example 27, further comprising means for decoding a challenge text encoded in the response frame based at least in part on the dialog token.

Example 29 may be any of examples 21 to 28, further comprising means for decoding the support code encoded in an advertisement protocol element of a generic advertisement service (GAS) response frame.

Example 30 may be example 29, further comprising means for decoding the support code encoded in a reserved value of the advertisement protocol element of the GAS response frame.

Example 31 may be a method comprising encoding a device class identifier in a request frame using a device, the device class identifier to identify a device class type; transmitting the request frame from the device to an access point; decoding a support code encoded in a response frame received at the device from the access point in response to the device class identifier encoded in the request frame; and determining that the access point is capable of associating with the device based at least in part on the support code.

Example 32 may be example 31, further comprising encoding the device class identifier in a generic advertisement service (GAS) request frame using the device.

Example 33 may be example 32, further comprising encoding the device class identifier in an advertisement protocol element of the GAS request frame.

Example 34 may be example 33, further comprising encoding the device class identifier in a reserved value of the advertisement protocol element of the GAS request frame.

Example 35 may be any of examples 31 to 34, further comprising advertising the device to the access point using the request frame.

Example 36 may be any of examples 31 to 35, further comprising wirelessly transmitting the request frame from the device to the access point.

Example 37 may be example 36, further comprising encoding a dialog token in the request frame.

Example 38 may be example 37, further comprising decoding a challenge text encoded in the response frame based at least in part on the dialog token.

Example 39 may be any of examples 31 to 38, further comprising decoding the support code encoded in an advertisement protocol element of a generic advertisement service (GAS) response frame.

Example 40 may be example 39, further comprising decoding the support code encoded in a reserved value of the advertisement protocol element of the GAS response frame.

Example 41 may be a device comprising memory circuitry to store instructions and processing circuitry to execute the instructions stored in the memory circuitry to decode a device class identifier from a request frame received at an access point from a device, the device class identifier to identify a type of the device, encode a support code in a response frame based at least in part on the device class identifier decoded from the request frame, and transmit the response frame from the access point to the device.

Example 42 may be example 41, wherein the processing circuitry executes the instructions stored in the memory circuitry further to decode the device class identifier from a generic advertisement service (GAS) request frame received at the access point from the device.

Example 43 may be example 42, wherein the processing circuitry executes the instructions stored in the memory circuitry further to decode the device class identifier in an advertisement protocol element of the GAS request frame received at the access point from the device.

Example 44 may be example 43, wherein the processing circuitry executes the instructions stored in the memory circuitry further to decode the device class identifier in a reserved value of the advertisement protocol element of the GAS request frame.

Example 45 may be any of examples 41 to 44, wherein the processing circuitry executes the instructions stored in the memory circuitry further to encode the support code in an advertisement protocol element of a generic advertisement service (GAS) response frame.

Example 46 may be example 45, wherein the processing circuitry executes the instructions stored in the memory circuitry further to encode the support code in a reserved value of the advertisement protocol element of the GAS response frame.

Example 47 may be any of examples 41 to 46, wherein the processing circuitry executes the instructions stored in the memory circuitry further to decode a dialog token from the request frame received at the access point from the device; generate challenge text based at least in part on the dialog token; and encode the challenge text in the response frame.

Example 48 may be example 47, wherein the processing circuitry executes the instructions stored in the memory circuitry further to wirelessly transmit the response frame from the access point to the device.

Example 49 may be example 48, wherein the processing circuitry executes the instructions stored in the memory circuitry further to receive an authentication frame at the access point from the device in response to the challenge text.

Example 50 may be example 49, wherein the processing circuitry executes the instructions stored in the memory circuitry further to associate the device to the access point based at least in part on the authentication frame received from the device.

Example 51 may be one or more computer-readable media comprising instructions stored thereon that, when executed by one or more processors, cause the one or more processors to decode a device class identifier from a request frame received at an access point from a device, the device class identifier to identify a type of the device; encode a support code in a response frame based at least in part on determining that the access point supports the type of the device in response to decoding the device class identifier from the request frame; and transmit the response frame from the access point to the device.

Example 52 may be example 51, wherein the instructions, when executed by the one or more processors, cause the one or more processors further to decode the device class identifier from a generic advertisement service (GAS) request frame received at the access point from the device.

Example 53 may be example 52, wherein the instructions, when executed by the one or more processors, cause the one or more processors further to decode the device class identifier from an advertisement protocol element of the GAS request frame received at the access point from the device.

Example 54 may be example 53, wherein the instructions, when executed by the one or more processors, cause the one or more processors further to decode the device class identifier in a reserved value of the advertisement protocol element of the GAS request frame.

Example 55 may be any of examples 51 to 54, wherein the instructions, when executed by the one or more processors, cause the one or more processors further to encode the support code in an advertisement protocol element of a GAS response frame.

Example 56 may be example 55, wherein the instructions, when executed by the one or more processors, cause the one or more processors further to encode the support code in a reserved value of the advertisement protocol element of the GAS response frame.

Example 57 may be any of examples 51 to 56, wherein the instructions, when executed by the one or more processors, cause the one or more processors further to decode a dialog token from the request frame received at the access point from the device; generate challenge text based at least in part on the dialog token; and encode the challenge text in the response frame.

Example 58 may be example 57, wherein the instructions, when executed by the one or more processors, cause the one or more processors further to wirelessly transmit the response frame from the access point to the device.

Example 59 may be example 58, wherein the instructions, when executed by the one or more processors, cause the one or more processors further to receive an authentication frame from the device in response to the challenge text.

Example 60 may be example 59, wherein the instructions, when executed by the one or more processors, cause the one or more processors further to associate the device to the access point based at least in part on the authentication frame received from the device.

Example 61 may be an apparatus comprising means for decoding a device class identifier from a request frame received at an access point from a device, the device class identifier to identify a type of the device; means for encoding a support code in a response frame based at least in part on the device class identifier decoded from the request frame; and means for transmitting the response frame from the access point to the device.

Example 62 may be example 61, further comprising means for decoding the device class identifier from a generic advertisement service (GAS) request frame received at the access point from the device.

Example 63 may be example 62, further comprising means for decoding the device class identifier in an advertisement protocol element of the GAS request frame received at the access point from the device.

Example 64 may be example 63, further comprising means for decoding the device class identifier in a reserved value of the advertisement protocol element of the GAS request frame.

Example 65 may be any of examples 61 to 64, further comprising means for encoding the support code in an advertisement protocol element of a generic advertisement service (GAS) response frame.

Example 66 may be example 65, further comprising means for encoding the support code in a reserved value of the advertisement protocol element of the GAS response frame.

Example 67 may be any of examples 61 to 66, further comprising means for decoding a dialog token from the request frame received at the access point from the device; means for generating challenge text based at least in part on the dialog token; and means for encoding the challenge text in the response frame.

Example 68 may be example 67, further comprising means for wirelessly transmitting the response frame from the access point to the device.

Example 69 may be example 68, further comprising means for receiving an authentication frame from the device in response to the challenge text.

Example 70 may be example 69, further comprising means for associating the device to the access point based at least in part on the authentication frame received from the device.

Example 71 may be a method comprising decoding a device class identifier from a request frame received at an access point from a device, the device class identifier to identify a type of the device; determining whether the access point is capable of supporting the type of the device based at least in part on the device class identifier decoded from the request frame; encoding a support code in a response frame based at least in part on the determining; and transmitting the response frame from the access point to the device.

Example 72 may be example 71, further comprising decoding the device class identifier from a generic advertisement service (GAS) request frame received at the access point from the device.

Example 73 may be example 72, further comprising decoding the device class identifier in an advertisement protocol element of the GAS request frame received at the access point from the device.

Example 74 may be example 73, further comprising decoding the device class identifier in a reserved value of the advertisement protocol element of the GAS request frame.

Example 75 may be any of examples 71 to 74, further comprising encoding the support code in an advertisement protocol element of a generic advertisement service (GAS) response frame.

Example 76 may be example 75, further comprising encoding the support code in a reserved value of the advertisement protocol element of the GAS response frame.

Example 77 may be any of examples 71 to 76, further comprising decoding a dialog token from the request frame received at the access point from the device, generating challenge text based at least in part on the dialog token, and encoding the challenge text in the response frame.

Example 78 may be example 77, further comprising wirelessly transmitting the response frame from the access point to the device.

Example 79 may be example 78, further comprising receiving an authentication frame at the access point from the device in response to the challenge text.

Example 80 may be example 79, further comprising associating the device to the access point based at least in part on the authentication frame received from the device.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments.

Moreover, some embodiments may include apparatuses or systems having any suitable means for carrying out the various operations of the above-described embodiments. The above description of illustrated embodiments, including what is described in the Abstract, is not intended to be exhaustive or to limit the embodiments of the present disclosure to the precise forms disclosed. The disclosure describes specific implementations and examples for illustrative purposes. Those skilled in the art will recognize that various equivalent modifications are possible within the scope of the present disclosure. These modifications may be made to embodiments of the present disclosure in light of the above detailed description.

The terms included in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

1. A device, comprising:
memory circuitry to store instructions; and
processing circuitry to execute the instructions stored in the memory circuitry to:
encode a device class identifier in a request frame, the device class identifier to identify a device class type of a device;
transmit the request frame from the device to an access point;
decode a support code encoded in a response frame received at the device from the access point in response to the device class identifier; and
determine that the device is capable of authenticating and associating with the access point based at least in part on the response frame.

2. The device of claim 1, wherein the processing circuitry is to further execute the instructions stored in the memory device to:
encode the device class identifier in a generic advertisement service (GAS) request frame using the device.

3. The device of claim 2, wherein the processing circuitry is to further execute the instructions stored in the memory device to:
encode the device class identifier in an advertisement protocol element of the GAS request frame.

4. The device of claim 1, wherein the processing circuitry is to further execute the instructions stored in the memory device to:
encode a dialog token in the request frame.

5. The device of claim 4, wherein the processing circuitry is to further execute the instructions stored in the memory device to:
decode a challenge text encoded in the response frame based at least in part on the dialog token.

6. The device of claim 1, wherein the processing circuitry is to further execute the instructions stored in the memory device to:
decode the support code encoded in an advertisement protocol element of a generic advertisement service (GAS) response frame.

7. One or more computer-readable media comprising instructions stored thereon that, when executed by one or more processors, cause a device to:
encode a device class identifier in a request frame, the device class identifier to identify a device class type of the device;
transmit the request frame from the device to an access point;
decode a support code encoded in a response frame received at the device from the access point in response to the request frame, the support code to indicate whether the access point is capable of associating with the device; and
associate the device with the access point in response to the support code.

8. The one or more computer-readable media of claim 7, wherein the instructions, when executed by the one or more processors, cause the device further to:
encode the device class identifier in a generic advertisement service (GAS) request frame using the device.

9. The one or more computer-readable media of claim 8, wherein the instructions, when executed by the one or more processors, cause the device further to:
encode the device class identifier in an advertisement protocol element of the GAS request frame.

10. The one or more computer-readable media of claim 7, wherein the instructions, when executed by the one or more processors, cause the device further to:
encode a dialog token in the request frame.

11. The one or more computer-readable media of claim 10 wherein the instructions, when executed by the one or more processors, cause the device further to:
decode a challenge text encoded in the response frame based at least in part on the dialog token.

12. The one or more computer-readable media of claim 11, wherein the instructions, when executed by the one or more processors, cause the device further to:
decode the support code encoded in an advertisement protocol element of a generic advertisement service (GAS) response frame.

13. A device, comprising:
memory circuitry to store instructions; and
processing circuitry to execute the instructions stored in the memory circuitry to:
decode a device class identifier from a request frame received at an access point from a device, the device class identifier to identify a type of the device;
encode a support code in a response frame based at least in part on the device class identifier decoded from the request frame; and
transmit the response frame from the access point to the device.

14. The device of claim 13, wherein the processing circuitry executes the instructions stored in the memory circuitry further to:
decode the device class identifier from a generic advertisement service (GAS) request frame received at the access point from the device.

15. The device of claim 14, wherein the processing circuitry executes the instructions stored in the memory circuitry further to:
decode the device class identifier in an advertisement protocol element of the GAS request frame received at the access point from the device.

16. The device of claim 13, wherein the processing circuitry executes the instructions stored in the memory circuitry further to:
encode the support code in an advertisement protocol element of a generic advertisement service (GAS) response frame.

17. The device of claim 13, wherein the processing circuitry executes the instructions stored in the memory circuitry further to:
decode a dialog token from the request frame received at the access point from the device;
generate challenge text based at least in part on the dialog token; and
encode the challenge text in the response frame.

18. The device of claim 17, wherein the processing circuitry executes the instructions stored in the memory circuitry further to:
receive an authentication frame at the access point from the device in response to the challenge text; and
associate the device to the access point based at least in part on the authentication frame received from the device.

19. One or more computer-readable media comprising instructions stored thereon that, when executed by one or more processors, cause a device to:
decode a device class identifier from a request frame received at an access point from a device, the device class identifier to identify a type of the device;
encode a support code in a response frame based at least in part on determining that the access point supports the type of the device in response to decoding the device class identifier from the request frame; and
transmit the response frame from the access point to the device.

20. The one or more computer-readable media of claim 19, wherein the instructions, when executed by the one or more processors, cause the device further to:
decode the device class identifier from a generic advertisement service (GAS) request frame received at the access point from the device.

21. The one or more computer-readable media of claim 20, wherein the instructions, when executed by the one or more processors, cause the device further to:
decode the device class identifier from an advertisement protocol element of the GAS request frame received at the access point from the device.

22. The one or more computer-readable media of claim 19, wherein the instructions, when executed by the one or more processors, cause the device further to:
encode the support code in an advertisement protocol element of a GAS response frame.

23. The one or more computer-readable media of claim 19, wherein the instructions, when executed by the one or more processors, cause the device further to:
decode a dialog token from the request frame received at the access point from the device;
generate challenge text based at least in part on the dialog token; and
encode the challenge text in the response frame.

24. The one or more computer-readable media of claim 23, wherein the instructions, when executed by the one or more processors, cause the device further to:
receive an authentication frame from the device in response to the challenge text; and
associate the device to the access point based at least in part on the authentication frame received from the device.
